(19) United States
(12) Patent Application Publication
(10) Pub. No.: US 2005/0171686 A1
(43) Pub. Date: Aug. 4, 2005

(54) Method and apparatus for obtaining and providing information related to a point-of-interest

(76) Inventor: Scott B. Davis, Walworth, WI (US)

Correspondence Address: Michael G. Fletcher;Fletcher Yoder, P.O. Box 692289, Houston, TX, 77269-2289, US

(21) Appl. No.: 10/769,013

(22) Filed: Jan. 30, 2004

(51) Int. Cl. G01C 21/26

(52) U.S. Cl. 701/200; 701/209; 340/995.19

(57) ABSTRACT

In an exemplary embodiment of the present technique, a particular POI (66) may be assigned a code (68) representative thereof. Advantageously, by entering the code (68) into a telematics system (16), information about the POI (66) may be obtained. Moreover, in accordance with an exemplary aspect of the present technique, by entering the code (68) a route to the POI may be developed.

### FIELD OF THE INVENTION

The present technique relates to a telematics system and, more particularly, to methods and apparatus for obtaining and providing information relating to a point-of-interest via a telematics system in response to a code pre-assigned to represent the point-of-interest.

### BACKGROUND INFORMATION

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

With recent advancements in communication technology, more and more information may be accessed and developed remotely. That is, information may be developed and/or accessed in mobile environments, such as in a vehicle or on a cellular phone. The use of mobile devices, or devices in mobile environments, to provide communication, comfort, and convenience information to a user is generally known to those of ordinary skill in the pertinent art as telematics. By way of example, typical telematics devices include cellular phones, Global Positioning System (GPS) receivers, and in-vehicle navigation systems, to name but a few.

In many instances, a user of a telematics device may have a particular point-of-interest (POI) about which he wishes to obtain more information. For example, the user may wish to find the location, address, and/or phone number of a particular restaurant. In traditional systems, to obtain such desired information, the user would have to at least partially enter the name of the restaurant. On a traditional numeric keypad, it may be difficult to enter an alphabetic name of the restaurant. Indeed, in a moving vehicle, for example, typing a relatively long restaurant name into a navigation system may be burdensome. Moreover, it may be difficult to obtain and recall the exact spelling of the name of the restaurant from a passing advertisement, such as a billboard.

In certain telematics systems, many of the concerns regarding the input of information requests are mitigated by information centers, which are manned by operators. That is, in these manned telematics systems, the driver, for example, contacts a live operator to obtain information about a particular POI by pressing a button to initiate communication with a manned center. Although effective, manned information centers are relatively expensive to operate. This cost of operation may be passed onto the consumer, thereby making such manned services less attractive than automated services. Moreover, data retrieval times of manned centers are limited by the operator's ability to sift through available information before him, thereby often providing information at a slower rate then automated systems.

### BRIEF DESCRIPTION OF THE DRAWINGS

Advantages of the invention may become apparent upon reading the following detailed description and upon reference to the drawings in which:

FIG. 1 is a diagram of an exemplary telematics network in accordance with aspects of the present technique;

FIG. 2 is a block diagram of an exemplary telematics system in accordance with the present technique;

FIG. 3 is a diagram representing an exemplary telematics setting for use of the exemplary telematics system of FIG. 2 in accordance with aspects of the present technique; and

FIG. 4 is a flow chart presenting stages in an exemplary process for employing the telematics system of FIG. 2 in the setting of FIG. 3 in accordance with aspects of the present technique.

### DETAILED DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

According to one embodiment, an exemplary telematics system is provided. In the exemplary system, pertinent locations (i.e., points-of-interest or POIs) are each assigned an arbitrary code that is representative thereof. That is, each POI is assigned a code that does not alphanumerically and substantially correspond to the alphanumeric name of the POI. Indeed, each code may be numeric, e.g., “12345,” or predominately numeric, e.g., “*12345#,” because such codes are easy to remember and enter. To obtain information about the POI, an individual may simply enter the code pre-assigned to represent the POI into a telematics device to retrieve the desired information. For example, the individual may enter a five-digit code pre-assigned to represent a POI into the telematics device, which, in response to the code, may automatically obtain a wealth of information about the POI from a database. Advantageously, the individual may be more easily able to enter the code rather than the name of the POI into a telematics device. Moreover, the code may be more easily recalled by and disseminated to an individual, thereby increasing the efficacy of telematics systems employing the present technique.

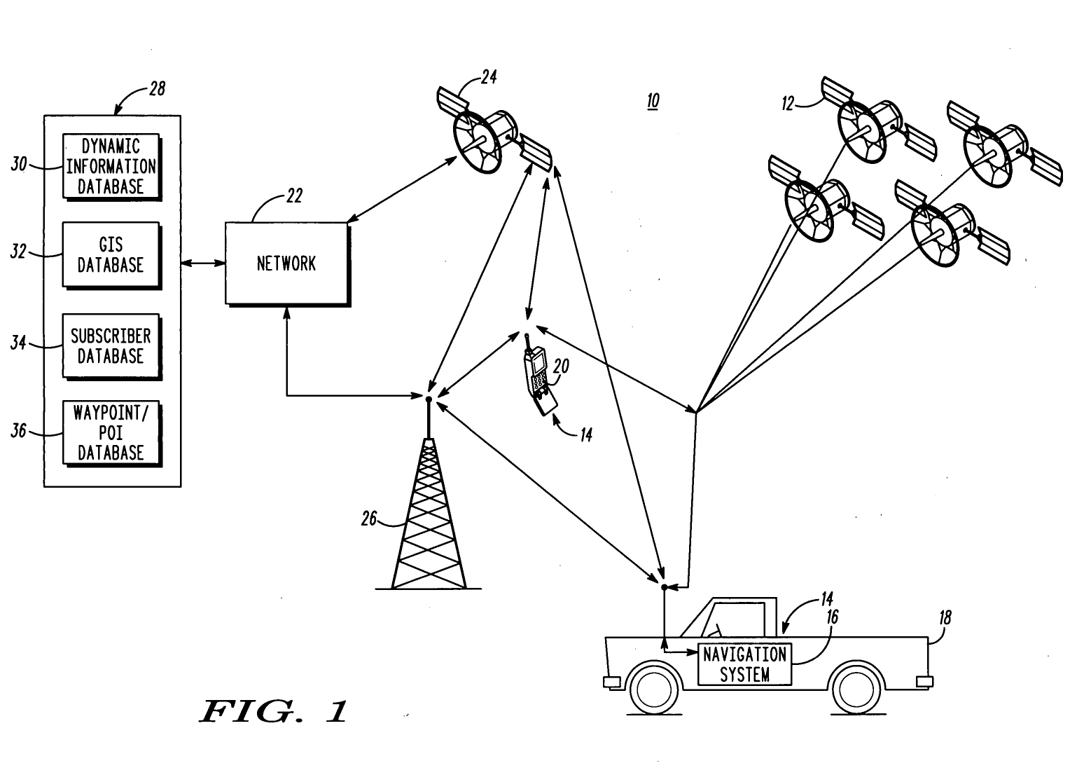

Turning to the figures, and referring initially to FIG. 1, an exemplary telematics network-web 10 is illustrated. Advantageously, the telematics network-web 10 may provide comfort, convenience and/or communication information, to name but a few kinds of information, to users of mobile device or devices in mobile environments. Moreover, the telematics network-web 10 may facilitate the exchange of data between various devices and data centers. As discussed below, the exemplary telematics network-web 10 may be configured to provide information to, by way of example, a vehicle navigation system, a cellular phone, or any other suitable telematics system. Advantageously, the exemplary telematics network-web 10 may be compatible with a satellite based positioning system, such as the Global Positioning System (GPS), as well as a terrestrial signal-posting system, to name but a few.

In the exemplary telematics network-web 10, a constellation of positioning satellites, such as GPS satellites 12, continually orbit the earth. By way of example, the United States Department of Defense operates a constellation of twenty-four GPS satellites 12 collectively known as NAVSTAR. Each GPS satellite 12 broadcasts a signal containing a precise location of the satellite and a precise time. Advantageously, a GPS device receives these signals and determines the device's location. As appreciated by those of ordinary skill in the pertinent art, by comparing the signals from three or more GPS satellites 12, in a process generally known to those in the art as trilateration, the position of the GPS device may be determined. Moreover, to improve the accuracy of the determination, four or more GPS satellites 12 may be employed to accurately determine the altitude of the GPS device.

The signal from the GPS satellites 12 may be received by a telematics system 14 located in a mobile environment, such as a navigation system 16 located in a vehicle 18, or by a portable telematics system 14, such as a hand-held GPS receiver or cellular phone 20. As appreciated by those of ordinary skill in the art, and as discussed above, by comparing (i.e., trilaterating) the signals from three or more GPS satellites 12, the telematics system 14 is able to determine the location of the vehicle 18 or the hand-held cellular phone 20 accurately. A number of advantages, as discussed further below, may be realized by determining the location of a mobile device (e.g., cellular phone 20) or mobile environment (e.g., vehicle 18) with relative precision. To correct for errors in the GPS signal, the telematics system 14 may be compatible with a Differential-GPS (DPGS) broadcast signal, as appreciated by those of ordinary skill in the art. Simply put, a DPGS broadcast device (not shown) gauges the inaccuracies in a GPS satellite signal and broadcasts a corrective signal to the telematics systems 14 within its broadcast radius.

The telematics systems 14 may be in communication with a network 22, such as a Local Area Network (LAN), a Server Area Network (SAN), a Metropolitan Area Network (MAN), a Wide Area Network (WAN), or any other suitable kind of network. Advantageously, as discussed further below, a wide variety of data may be communicated between the network 22 and the telematics systems 14. This communication may occur over any number of wireless protocols such as, Global Standard for Mobile (GSM), Time Division for Multiple Access (TDMA), Code Division Multiple Access (CDMA), Frequency Division Multiple Access (FDMA), radio frequencies (RF), and any other suitable communications protocol.

In the exemplary telematics network-web 10, the telematics system 14 may be linked to the network 22 via a network communication satellite 24. Accordingly, by employing a wireless protocol, examples of which are discussed above, the network communications satellite 24 may act as a conduit for communicating data between the network 22 and the respective telematics system 14 (e.g., the navigation system 16 and/or the cellular phone 20). Moreover, the network communications satellite 24 may also act as a conduit for communications between the telematics systems 14 themselves. That is, data, such as a text message, may be transmitted from the cellular phone 20 up to the network satellite 24, and back down to the navigation system 16 in the vehicle 18. In many instances, it may be more advantageous to use a terrestrial-based communication link for transmitting data between the network 22 and the telematics systems 14 or between the telematics systems 14 themselves. By way of example, the network 22 and the telematics systems 14 may be coupled to one another via a terrestrial transceiver 26, such as a communications tower. As appreciated by those of ordinary skill in the art, such terrestrial transceivers 26 may communicate data over any number of wireless protocols, such as the exemplary wireless protocols discussed above. Advantageously, terrestrial transceivers 26 may receive relatively weak signals from the telematics systems 14 or the network 22, amplify the signal, and broadcast the amplified signal over distances, thereby acting as a signal repeater. For example, the cellular phone 20 may not have sufficient power or transmission capacity to send signals over relatively long distances. Accordingly, the relatively weak signal transmitted by the cellular phone 20 may be received by a terrestrial transceiver 26, amplified, and repeated to the network 22, to another terrestrial transmitter 26, to another cellular phone 20, or to the network communication satellite 24. Advantageously, terrestrial transceivers 26 may be employed in areas of poor signal transmission, such as tunnels or mountainous regions, to improve communications between the telematics systems 14 and the network 22. Moreover, data in telematics network-web 10 may also be communicated via terrestrial transceivers 26 and network communication satellites 24 concurrently.

Via the network 22, the telematics systems 14 may access any number of databases, for example, which provide information. By way of example, a service provider server 28, which is updated and maintained by a service provider, may be accessible via the network 22. The service provider server 28 may maintain any number of databases, such as a dynamic information database 30, a Geographic Information System (GIS) database 32, a subscriber database 34, and a waypoint or POI database 36, as discussed further below. Advantageously, the service provider may update the databases 30-36 regularly, thereby providing up-to-date information and data accessible via the network 22. However, as discussed further below, the databases 30-36 may be local to the telematics systems 14. That is, the databases 30-36 may be accessible by the telematics systems 14 independent of the network 22, and/or locally with respect to the telematics system 14.

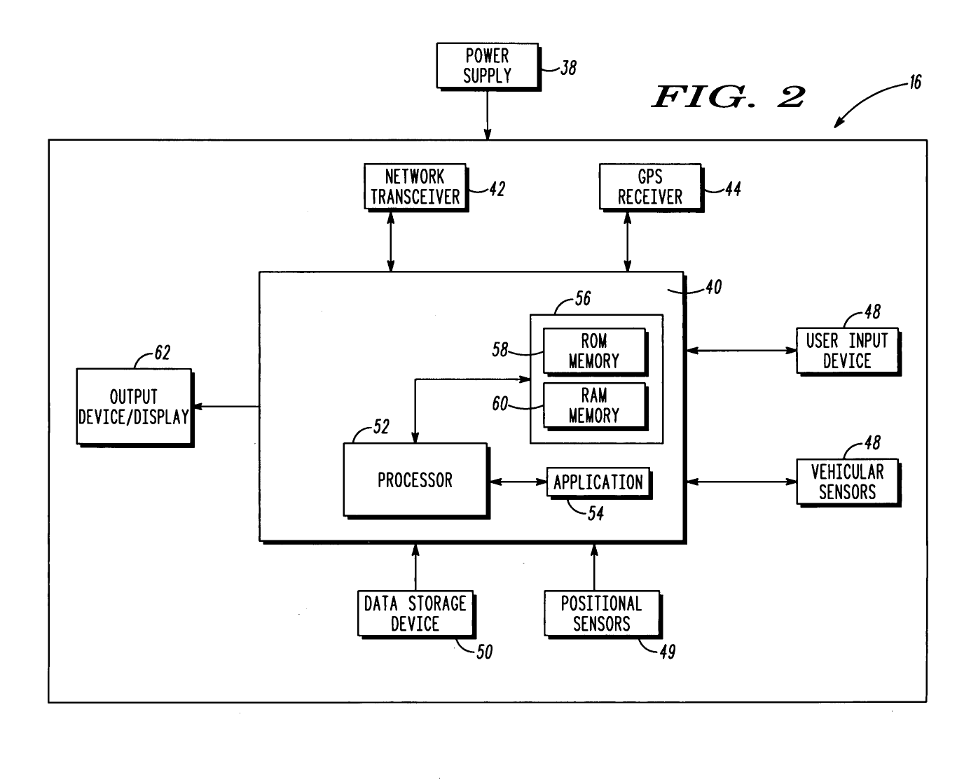

Turning to FIG. 2, an exemplary telematics system 14, such as an exemplary vehicular navigation system 16, is illustrated. To power the exemplary navigation system 16, a power supply 38 may provide power via a battery, generator, or any other suitable power source. In the exemplary navigation system 16, 12V dc power may be provided by the electrical system of the vehicle 18 (see FIG. 1). As appreciated by those of ordinary skill in the art, power may be distributed throughout the components of the navigation system 16 via conventional methods.

The navigation system 16 may include a number of components that provide inputs to a control module 40, which may process information and control the operation of the navigation system 16 as discussed further below. For example, the navigation system 16 may include a network transceiver 42, which facilitates communication between the navigation system 16 and the network 22 (see FIG. 1). That is, the network transceiver 42 may both transmit data to and receive data from the network 22. Moreover, the network transceiver 42 may operate in accordance with any number of wireless protocols, examples of which are discussed above. To receive signals from the GPS satellites 12 (see FIG. 1), the navigation system 16 may also include a GPS receiver 44.

Additionally, the control module 40 may receive inputs from various sensors located throughout the vehicle 18. For example, the navigation system 16 may include vehicular sensors 46, such as airbag sensors, engine sensors, or other kinds of sensors that provide information about the vehicle's 18 condition. Advantageously, such vehicle-condition information may be sent through the network 22 to the service provider for appropriate response. For example, if an airbag of the vehicle deployed, the navigation system 16 may inform the service provider. The service provider may then request the assistance of emergency personnel. Furthermore, the control module 40 may receive inputs from a user input device 48, such as a keypad, a touchscreen, and a voice recognition system, and/or any other suitable manual data-entry device.

To aid in navigation, the control module 40 may also receive information from positional sensors 49, such as inertial sensors, gyros, and accelerometers, to name but a few. As appreciated by those of ordinary skill in the pertinent art, such positional sensors 48 may monitor movements of the vehicle 16 and determine the location of the vehicle by comparing such movements to pre-existing geographic data. That is, the positional sensors 48 may compare the movements of the car to preexisting routes, maps and/or other geographical data stored on a data storage device 50, such as a compact-disc (CD) or digital-video-disc (DVD) in a disk drive, a hard-disk drive, or any other suitable data storage device, thereby determining the likely location of the vehicle 18. Indeed, such positional sensors 48 may buttress the determination of the vehicle's location made via the GPS components.

To manage and process the incoming data, and to control operations of the navigation system 16, the control module 40 may include a processor 52, such as a microprocessor, available from, for example, Motorola, Inc. of Schaumburg, Illinois. The processor 52 may process data received from the various components and provide output data to any number of components and/or to the individual. Moreover, the processor 52 may provide instructions and commands to the various components of the navigation system 16. Many of these responses (i.e., commands and output data) may be developed by a software application 54. By way of example, the software application 54 may receive GPS signals from the GPS receiver 44 as well as geographic data from the CD drive 50 and correlate the received data to determine the location of the vehicle 16. Moreover, the application 54 may determine an ideal route between the vehicle's location and a POI, as discussed further below. As yet another example, the application 54 may comprise a browser configured to manage information, such as information retrieved from the Internet. Those of ordinary skill in the pertinent art appreciate browsers and the capabilities thereof.

The application 54 may be stored on an external device, such as the CD/DVD drive 50 or in memory 56 located in the control module 40. By way of example, the memory 56 may include random access memory (RAM) 58, dynamic random access memory (DRAM), static random access memory (SRAM), read-only memory (ROM) 60, flash memory, or any other suitable memory type, as appreciated by those of ordinary skill in the pertinent art. Advantageously, the memory 56 may also store data developed by the application 54, such as the output data discussed above.

Although, in the exemplary navigation system, the application 54 is presented as being local to the navigation device 16, the application 54 may also be maintained on the network 22 (see FIG. 1) and, as such, accessed remotely. That is, input data may be transmitted via the network 22, processed remotely by the application 54 on the service provider server 28, and returned to the navigation system 16. For example, the navigation system 16 may transmit the vehicle's 18 location, via the network 22, to the appropriate server 28, on which the application 54 is maintained. The application 54 may then process the information (e.g., build a route from the vehicle's location to a POI) and transmit the processed information (i.e., output data) back to the navigation system, again, via the network 22. Advantageously, the remote service provider server 28 may be able to process large amounts of data faster than a local processor 52, thereby decreasing the response time in providing desired information to a user.

The navigation system 16 may also include an output device 62, such as an LCD screen and/or an audio output device. Advantageously, the output device 62 may provide various types of information and output data to an individual in an understandable format quickly. For example, the output device 62, such as a LCD screen, may display a route, developed by the control module 40, thereby providing a route for travel between two locations or between the vehicle's location and a destination, as discussed further below. The various components of the navigation system 16 discussed above may be configured to communicate with one another wirelessly, in accordance with a wireless protocol, such as Bluetooth, infrared or RF communication protocols, or may also be configured to communicate via more traditional mechanisms (e.g., cables).

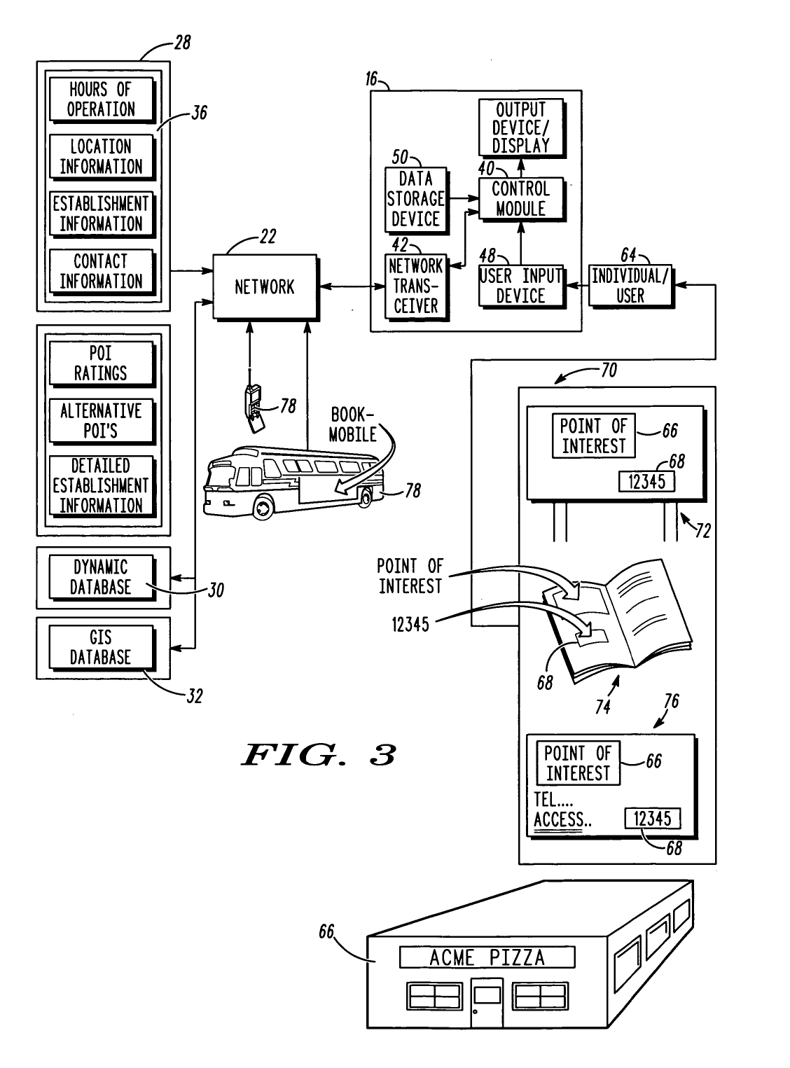

Turning next to FIG. 3, an exemplary setting for the use of the exemplary telematics system 14, such as the navigation system 16, of FIG. 2 is depicted. In the exemplary environment, an individual 64 may desire to obtain more information about a particular point-of-interest (POI) 66, such as a restaurant, a tourist attraction, a particular residence, a shopping mall, or a movie theater, to name but a few. Moreover, the individual 64 may desire to obtain information about a category of points-of-interest (POIs), such as a particular cuisine type or retail sales type. To index information about the POIs 66, a service provider and/or the individual 64 may pre-assign a unique, arbitrary code 68 to represent the particular POI 66 or category of POIs. The code 68 may be an arbitrary alphanumeric combination, sound, and/or any other suitable identifier that may be envisaged. Although an arbitrary code may in some manner correspond with the alphanumeric name of the POI 66, for the most part the arbitrary code does not correspond with the alphanumeric name of the POI 66. By way of example, a service provider may assign a numeric code 68 “12345”, or a predominantly numeric code, e.g., “*12345#,” to represent a particular POI 66. That is, the code 68, e.g., “12345” may be pre-assigned to represent a particular restaurant, for example. Indeed, the service provider, for example, may also assign the numeric code 68 “789” to represent restaurants that specialize in Indian cuisine. Advantageously, the service provider may serve as a clearinghouse for assigning the various codes 68 to the POIs, thereby ensuring that unique codes 68 are assigned to particular POIs and categories of POIs.

Because each POI 66 or category of POIs is assigned a unique arbitrary code 68, entering the code 68 into a telematics system 14 may retrieve information or data regarding the POI 66, as discussed further below. To obtain the codes 68, an individual 64 may come into contact with a code information source 70, such as a billboard 72, a magazine 74, a business card 76, an advertisement, or any other portal for conveying information. Alternatively, it should be understood that an individual 64 may also assign codes 68 to represent personally determined POIs 66, such as relatives homes, places of employment, client offices, and so forth. Advantageously, an individual 64 may find it easier to recall a simple alphanumeric code 68 in comparison to a POI's name. Moreover, entry of a simple alphanumeric code 68 onto a numeric keypad, commonly found in telematics systems 14, may be more convenient and less burdensome than entering the POI's 66 name (e.g., entering alphabetic name into a numeric keypad).

In the exemplary navigation system 16, the individual 64 may enter the code 68 into the input device 48. Upon entry of the code 68, the telematics system 14 may access a service provider server 28 containing information about the desired POI 66. For example, the telematics system may initiate communication with the service provider server in response to the code. More particularly, information about the desired POI may be found in one or more of the databases 30-36 maintained on the service provider server 28. These databases 30-36 may be remotely accessed by the telematics system 14 via the network 22 and the network transceiver 42. However, it should be understood the some if not all of the data maintained in the databases 30-36 may also be stored locally (e.g., in local memory 56 or on a CD/DVD in a storage drive 50) with respect to the telematics device 14, as discussed further below.

In an exemplary service provider server 28, there may be maintained a number of databases 30-36 containing various kinds of information. For example, the service provider server 28 may maintain a POI/waypoint database 36, which contains information about a POI's hours of operation, contact information, location information (i.e., address and coordinate location), as well as general information about the POI 66, such as the type of establishment of the POI 66 (e.g., a hardware store). The service provider server 28 may also maintain a GIS database 32 containing geographical data, such as maps, terrain conditions, and other sorts of geographical data related to the POI 66. Additionally, the service provider server 28 may maintain a dynamic information database 30, which contains information or data that may be frequently changing. For example, the dynamic information database 30 may include current events information, such as festivals and programs, related to the POI 66. Further yet, the service provider server 28 may maintain a subscriber database 34. The subscriber database 34 may be a premium database that contains more detailed information about the POI 66 to subscribing users. That is, access to the subscriber database 34 may be limited to those individuals subscribing to the service (e.g., paying a subscription fee). For example, the telematics system 14 and/or the network 22 may be configured to limit access to the subscriber database 34 to those who are verified as premium customers. Advantageously, by maintaining the exemplary databases 30-36 on a network server (i.e., service provider server 28 accessible via the network 22), the exemplary databases 30-36 may be updated to provide the most current and up-to-date information.

Alternatively, the data found in the databases 30-36 may be maintained by local memory components, such as the CD/DVD drive 50 or the memory modules 56. Advantageously, the individual 64 may be able to obtain information regarding a POI 66 without a network 22. For example, to find the phone number of a particular restaurant or POI 66, an individual 64 may simply enter the appropriate code 68 into the telematics system 14, as discussed above. It should be noted that when employing locally maintained databases 30-36, the code 68 may be transmitted to the appropriate memory device (e.g., the CD/DVD drive 50 and the memory modules 56) in which the database 30-36 is stored either wirelessly or traditionally (e.g., cables). Upon receipt of a request corresponding to the code 68, the desired information about the POI 66 may be retrieved from the appropriate database 30-36 in a manner similar to the networked system discussed above.

Returning to the networked system, information regarding mobile POIs, such as other vehicles (e.g., a bookmobile, mobile health clinic) and/or another telematics system, such as a hand-held cellular phone, may be communicated via the network 22. For example, to determine the location of the mobile POI 78, the mobile POI 78 may contain positioning systems, such as the GPS or terrestrial positioning systems discussed above. The mobile POI 78 may then transmit its location via the network 22 to the service provider server 28. In turn, the service provider sever 28 may maintain this information (in a database for example) and provide this information in response to a requesting telematics system, e.g., a telematics system that is providing a code representative of the mobile POI 78. For example, the telematics system 14 may be configured to build a route from the telematics system's 14 location to the locations of the mobile POIs' 78.

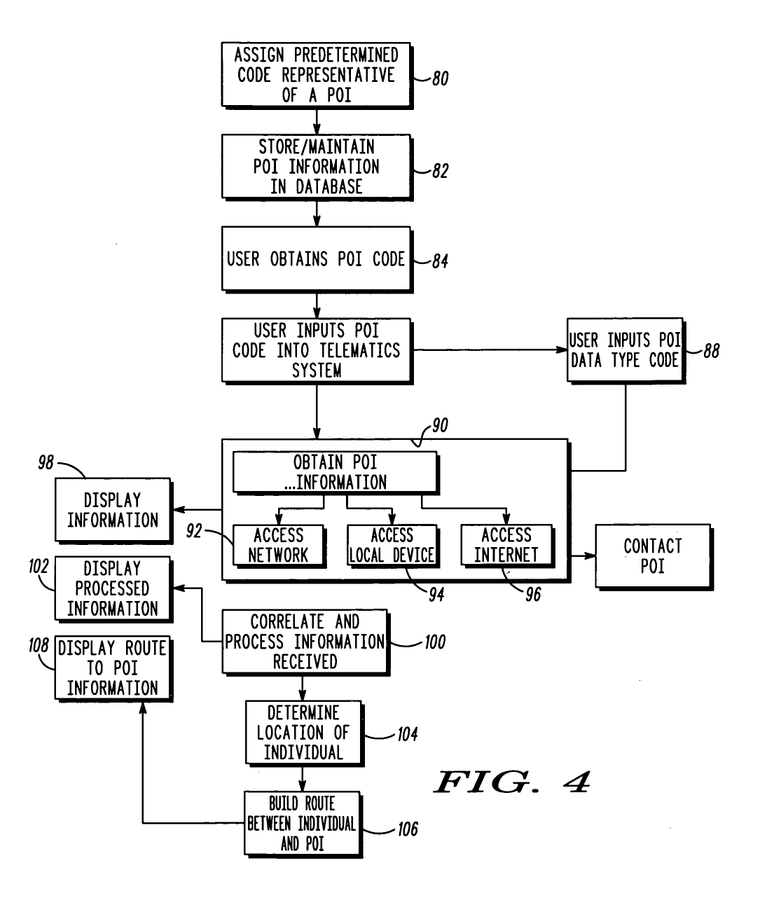

Turning next to FIG. 4, and keeping FIGS. 1-3 in mind, a flow chart depicting various stages of an exemplary process in accordance with the present technique is provide. As represented by block 80, a service provider may assign a code 68 to represent a POI 66 or a category of POI(s). By way of example, the service provider may assign all ACME Pizza restaurants the numeric code “45678,” or the service provider may assign the code “456789” to a particular ACME Pizza restaurant. In either event, the service provider may then correlate (or index) information regarding the POI to the code 68. The information may then be stored in a database (e.g., databases 30-36), as represented by block 82. As discussed above, the databases 30-36 may be maintained on a service provide server 28 in a network 22, or they may be stored locally with respect to the telematics system 14 in a storage device 50, such as a hard-disk drive.

Advantageously, ACME Pizza may advertise to individuals (i.e., consumers) that more information about ACME Pizza may be obtained by entering the code 68 into an appropriately configured telematics system 14. As represented by block 84, an individual 64 may obtain the code 68 from any number of sources, such as the exemplary advertisements discussed above.

Once the individual 64 has obtained the code 68, the individual may then enter the code into the telematics device 14, as discussed above and as represented by block 86. Advantageously, as represented by block 88, the individual 64 may also enter an information identifier or data-type code into the telematics system 14 to obtain a particular type of data from the databases. For example, an individual 64 may enter the code “45678,” representative of ACME Pizza, followed by a data-type code, such as “* 1,” to obtain a particular type of data about the ACME Pizza (e.g., ACME Pizza's phone number). Moreover, as discussed further below, the data-type code (e.g., “* 1”) may also instruct the telematics system 14 to perform certain functions, such as dialing the phone number retrieved. However, as appreciated by those of ordinary skill in the art, the individual may also manage retrieved information and/or place information requests via an information management portal, such as a browser or a selection menu.

Upon entry of the appropriate codes, the telematics system 14 may request retrieval of data related to the POI (e.g., ACME Pizza) from the appropriate databases 30-36, as represented by block 90. The databases 30-36 may be located in a number of data storage types, and, as such, may be accessed via various protocols. For example, the databases 30-36 may be accessed from a network 22, as represented by block 92. Alternatively, as represented by block 94, the databases 30-36 may be maintained and accessed locally with respect to the telematics system 14. In this exemplary instance, the code 68, as well as the data from the databases 30-36, may be communicated to and from a local storage device 50, such as a hard-disk drive or CD/DVD drive, as discussed above, in a manner appreciated by those of ordinary skill in the art. In yet another exemplary alternative mechanism for data communications, the databases 30-36 may be maintained in an independent network 22, such as the Internet. As represented by block 96, a wireless broadband signal, such as IEEE 802.11 (b) or RF may facilitate the communications with the Internet. Moreover, access to the Internet may also be achieved via a wireless application protocol (WAP). Retrieved data, as well as the requests for data, may be managed by a browser, the likes of which are appreciated by those of ordinary skill in the art.

Once the desired data has been obtained from the appropriate databases 30-36, the telematics system 14 may then process the data. For example, if the individual 64 has requested the phone number for ACME Pizza, the telematics system may then output the phone number to a display device 62, as represented by block 98. Additionally, the telematics system 14 may receive the requested data, again the exemplary phone number, and initiate contact with the POI, ACME Pizza, for example. That is, the telematics system 14 may dial the phone number of ACME Pizza automatically, thereby initiating contact with ACME Pizza.

As another example of retrieved data-type, the databases 30-36 may provide locational information about the POI 66, as well as other geographical data. That is, the databases may provide the geographic location of ACME Pizza, as well as a map, to the telematics system 14. In response, the telematics system 14 may correlate the data about the POI's location with the geographical data, and provide the newly synthesized data to the individual 64, as represented respectively by blocks 100 and 102. By way of example, and as represented by block 102, the telematics system 14 may build and display a map presenting the location of ACME Pizza to the individual 64. As discussed above, the correlation of data and the synthesis of data may be performed locally on the telematics system 14 and/or performed remotely on the service provider server 28. Advantageously, by entering the code 68 representative of the POI rather than the alphabetic name of the POI, the individual may be able to determine the POI's location in a less burdensome and more efficient manner. Moreover, the individual may be able to obtain the location of an ACME Pizza in an unfamiliar city simply by entering the code representative of the ACME Pizza chain.

Additionally, as represented by block 104, the telematics system 14 may determine an individual's 64 location via a positioning device (e.g., GPS receiver 44), examples of which were discussed above. With the individual's location, the telematics system 14 may output data comparative of the POI's location and the individual's location. For example, the telematics system 14 may determine a route for travel between the individual's location and the location of ACME Pizza, as represented by block 106. Moreover, the telematics system 14 may synthesize other data, such as traffic conditions and road speeds, to determine an optimum route of travel to ACME Pizza. However, it should be noted that the route may also be determined remotely on the network 22. That is data may be correlated and synthesized remotely on the network 22 and, subsequently, transmitted to the telematics system 14. Once the route has been determined, the route may then be display on the telematics system 14, as represented by block 108.

While the invention may be susceptible to various modifications and alternative forms, specific embodiments have been shown by way of example in the drawings and have been described in detail herein. However, it should be understood that the invention is not intended to be limited to the particular forms disclosed. For example, as stated above, the present invention may be employed in any number of modalities. The invention is to cover all modifications, equivalents, and alternatives falling within the spirit and scope of the invention as defined by the following appended claims.

1. A telematics assembly, comprising:
an input device configured to receive an arbitrary code pre-assigned to correspond to a point-of-interest (POI);
a communication device configured to initiate communication with a database having data related to the POI in response to the code; and
a receiving device configured to receive the data related to the POI from the database.

2. The telematics assembly as recited in claim 1, wherein the receiving device comprises a display configured to present the data related to the POI visually.

3. The telematics assembly as recited in claim 1, comprising a positioning device configured to provide the location of the telematics assembly.

4. The telematics assembly as recited in claim 1, wherein the communication device is configured to communicate with a wireless network.

5. The telematics assembly as recited in claim 4, wherein the database is accessible via the wireless network.

6. The telematics assembly as recited in claim 1, comprising a data storage device, wherein the database is maintained on the data storage device.

7. The telematics assembly as recited in claim 6, wherein the data storage device is configured to communicate wirelessly with at least one of the input device and the receiving device.

8. A telematics system for use by an individual, comprising:
an input device configured to receive an arbitrary code pre-assigned to correspond to a point of interest (POI) for facilitating transmittal of a request to a database having information about a location of the POI, the database being configured to provide the information about the location of the POI in response to the request;
a receiving device configured to receive the information about the location of the POI from the database;
a navigation device configured to determine a location of the individual to provide output data comparative of the location of the individual and the location of the POI; and
an output device configured to present the output data to the individual.

9. The telematics system as recited in claim 8, wherein the navigation device is configured to determine at least one route for travel between the location of the individual and the location of the POI.

10. The telematics system as recited in claim 8, the output device comprises a display for displaying the output data to the individual visually.

11. The telematics system as recited in claim 8, wherein the input device comprises a keypad.

12. The telematics system as recited in claim 8, comprising a data communication device configured to communicate via a wireless network, wherein the database is accessible via the wireless network.

13. The telematics system as recited in claim 12, wherein the network provides a link to a remote processor configured to develop the output data.

14. A telematics system for use by an individual, comprising:
a vehicle; and
a navigation system located in the vehicle, comprising:
an input device configured to receive an arbitrary code pre-assigned to represent a point-of-interest (POI) for facilitating transmittal of a request to a database having data related to the POI, the database being configured to provide the data related to the POI in response to the request;
a positioning device configured to provide a location of the vehicle; and
a receiving device configured to receive the data related to the POI from the database.

15. The telematics system as recited in claim 14, comprising a display device communicatively coupled to the receiving device and configured to display the data related to the POI to the individual.

16. The telematics system as recited in claim 14, comprising a data communication device configured to communicate via a wireless network.

17. The telematics system as recited in claim 16, wherein the database having data related to the POI is accessible via the network.

18. The telematics system as recited in claim 17, wherein the data related to the POI includes a location of the POI, and wherein a server is configured to provide to the receiving device output data comparative of the location of the vehicle and the location of the POI.

19. The telematics system as recited in claim 18, wherein the output data includes at least one route for travel between the location of the vehicle and the location of the POI.

20. The telematics system as recited in claim 14, wherein the data related to the POI includes data related to a location of the POI, and wherein the navigation system is configured to determine at least one route for travel between the location of the vehicle to the location of the POI.

21. A method of providing data relating to a point-of-interest (POI), comprising the acts of:
receiving a communication initiation request from a telematics device, wherein the telematics device developed the communication initiation request in response to entry of an arbitrary code pre-assigned to represent the POI into the telematics device;
receiving a request from the telematics device, wherein the telematics device developed the request in response to entry of the arbitrary code into the telematics device;
obtaining information regarding the POI from a database in response to the request; and
providing the information regarding the POI to the telematics device.

22. The method as recited in claim 21, comprising the act of transmitting the information regarding the POI to the telematics device wirelessly.

23. The method as recited in claim 22, comprising the act of maintaining the database in a networked server.

24. The method as recited in claim 21, comprising the act of assigning a code to a discrete POI to index information about the POI in the database.

25. The method as recited in claim 21, comprising the act of providing information regarding a location of the POI to the telematics device.

26. The method as recited in claim 25, comprising obtaining a location of the telematics device and the location of the POI; and
developing at least one route for travel between the location of the telematics device and the location of the POI.

27. A method of obtaining information regarding a point-of-interest (POD, comprising the acts of:
inputting an arbitrary code pre-assigned to represent a POI into a telematics device configured to develop a request in response to the arbitrary code and to initiate communication with a database having information regarding the POI, wherein the request is configured for transmission to the database; and
receiving the information regarding the POI from the database via the telematics device.

28. The method as recited in claim 27, comprising the act of entering a data-type code into the telematics device for requesting a particular type of information regarding the POI.

29. The method as recited in claim 28, wherein the data-type code facilitates activation of a feature of the telematics device.

30. The method as recited in claim 27, comprising the act of following at least one route of travel between the POI and the telematics device developed via the telematics device.

31. The method as recited in claim 27, comprising the act of contacting the POI via the information regarding the POI received from the database.

32. A computer program located on a tangible medium, the program being configured for use with a telematics device in communication with a database having data regarding a point-of-interest (POI), comprising:
a routine for receiving an arbitrary code pre-assigned to correspond to the POI; and
a routine for requesting information related to the POI from the database in response to the arbitrary code.

33. A method of organizing information regarding a point-of-interest (POI), comprising:
assigning an arbitrary code to represent the POI; and
correlating the information regarding the POI to the code, the information regarding the POI being accessible during a communication session initiated by the telematics device via entry of the arbitrary code into the telematics device and in response to a request developed by the telematics device.
